(19) United States
(12) Patent Application Publication
(10) Pub. No.: US 2012/0284209 A1
(43) Pub. Date: Nov. 8, 2012

(54) RFID CONTROLLED PARKING SYSTEM

(76) Inventors: Douglas Duffy, New Brighton, PA (US); Mark Pitchford, Fombell, PA (US)

(21) Appl. No.: 13/099,839

(22) Filed: May 3, 2011

(51) Int. Cl. G06F 17/00; B60Q 1/48; G08G 1/01

(52) U.S. Cl. 705/418; 340/933; 340/932.2

(57) ABSTRACT

A customer-based electronic device (such as a cell phone or an embedded RFID chip in a vehicle's electronics) is combined with a facility-dispensed ticket to control vehicle entrance and exit to a controlled property. In one embodiment, a cell phone is used to provide a unique RFID number utilizing Near Field Communication (NFC) or similar technology for establishing entry and exit times, parking space control and automatic billing technology for each vehicle. In such an embodiment, a backup paper ticket is dispensed to each vehicle upon entry to the controlled property. The paper ticket contains a broadcast electronic signal (for example, an RFID signal) which is matched to the unique cell phone RFID number of the cell phone. The electronic system then controls all aspects of the vehicle's movement while on the property. This movement, in one embodiment, includes access to parking areas, access to special parking spots, such as reserved spaces, premium VIP, and handicapped areas. The system also can provide information as to how many spaces are available at any given time and exactly where the available spaces are located. In one embodiment, billing for the use of the property is accomplished automatically to accounts linked to the driver's cell phone.

### TECHNICAL FIELD

This disclosure relates to vehicle parking control systems, and more particularly to systems and methods for using electronic sensing to control parking access and even more particularly to systems and methods for combining a physical manifestation of an electronic code with a Near Field Communication and linking them together as well as to an automated payment system.

### BACKGROUND OF THE INVENTION

Currently many systems exist for parking access and revenue control at parking garages and other parking facilities. These systems range from issuance of paper mag stripe, barcode or punch hole tickets to each entering vehicle to electronic sensing of vehicles on parking pass basis or transponder basis. Sophisticated systems exist that read an electronic sensor (on fixed parking pass or transponder basis) of a vehicle upon entry and exist to a protected location (for example, an airport, a parking garage or an open lot) and then by calculating the elapsed time between entry and exit, charge the vehicle accordingly. In some systems this charge is deducted from a prepaid balance maintained in a database by vehicle basis and in other systems the charge is made against a credit card on file for a particular fixed electronic transponder or pass.

In some situations it is desired to know where available parking exists so that a vehicle need not spend time searching for an open space in which to park. VIP parkers or premium parkers as well as reservation parkers (prepaid over the web) are examples of parkers that would go to specific areas (special or restricted areas) of a parking facility to park. Usually such “available” parking notices are provided by sensing vehicle motion in a special or restricted area and then calculating how many spaces are remaining in that area. Some systems (such as the system shown in U.S. Pat. No. 7,899,583) are designed to send RF signals when a parking space is empty, the RF signal provides the location of the available space, often these types of solutions are active RFID fixed pass/transponder.

In some situations it is desired to charge a vehicle a premium for parking in a specific area or in a specific space. In other situations, it is desired to allow users to reserve parking in a specific area or in a specific space. In still other systems, it is desired to reduce fees to specific vehicles, such as those using wheelchair-only spaces or for those who have earned a distinguished status, for example, for those who have earned purple hearts.

Cell phone technology coupled with alliances with financial institutions, the environment now exists for the cell phone to be used in transacting for parking fees. Transacting with a cell phone device or like technology will reduce or eliminate the need for old smart technology in the exit lanes or entry lanes or the need for central “pay-on-foot” technology, all of this will represent savings to the Parking Industry. Thus, a comprehensive system for parking control should be able to accommodate these and other features in order to be robust and practical. Practicality is paramount in that such a comprehensive system must recognize the need to employ multiple/redundant backup processes and technology in the instance where cell phones are not used by the patron or the cell phone loses power.

### BRIEF SUMMARY OF THE INVENTION

A customer-based electronic device (such as a cell phone) is combined with a facility-dispensed paper RFID ticket with embedded RFID technology to control vehicle entrance and exit to a controlled property. In one embodiment, a cell phone is used to provide a cell phone RFID number utilizing near field communication (NFC) or the like. This number is linked to entry and exit times, parking space control and automatic billing for each vehicle. In such an embodiment, a backup paper ticket is dispensed to each vehicle upon entry to the controlled property. The paper ticket contains a broadcast electronic signal (for example, an RFID signal) which is matched to the unique cell phone RFID number of the cell phone. The electronic system then controls all aspects of the vehicle's movement while on the property. This movement, in one embodiment, includes access to parking areas, access to special parking spots, such as reserved spaces, premium (VIP) and handicapped areas. The system also can provide information as to how many spaces are available at any given time and exactly where the available spaces are located. In one embodiment, billing for the use of the property is accomplished automatically to accounts linked to the driver's cell phone.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of a vehicle control system using the concepts of the invention;

FIG. 2 shows one embodiment of the operation of a control system for coordinating an entering vehicle's cell phone RFID number with a dispensed paper RFID tag;

FIG. 3 shows one embodiment of the operation of a control system for coordinating parking locations within a facility on a per vehicle basis;

FIG. 4 shows one embodiment of the operation of a control system for processing an exiting vehicle and for automatically controlling billing for services, such as the use of a parking facility; and

FIG. 5 shows one embodiment of a method for using RFID technology to control access to data in the system.

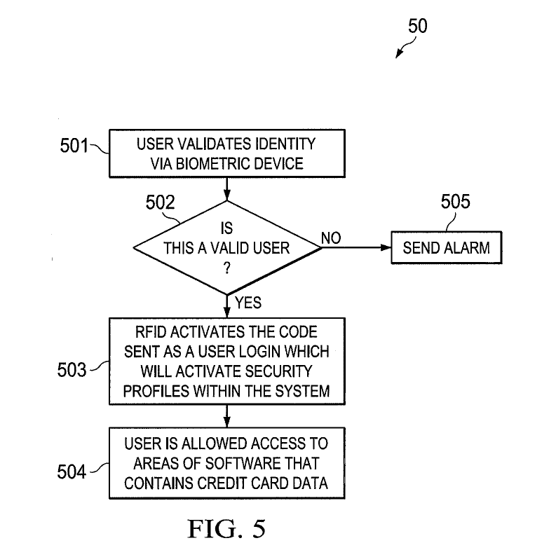

### GENERAL DESCRIPTION

The invention discussed herein leverages off of cell phone transaction and tracing technology or the like while considering realities associated with using cell phone technology. Such realities are some patrons will not use their cell phone to transact. In some cases, cell phones will be used to enter a facility but upon exiting a facility the cell phones are lost or power is lost. This invention also utilizes a paper RFID tag with embedded RFID technology (paper or any material could be used). This backup RFID technology continues to allow the parking facility to control parker movement and identify where they parked using similar RFID technology that the cell phone uses. Thus, backup RFID technology can be used like the cell phone with non-intelligent exit and entry devices in the lanes to automate the parking transaction thus reducing or eliminating the use of cash. This invention also provides a backup to a lost paper RFID tag by leveraging off of LPR (license plate recognition technology) to allow a parker to still use the non-intelligent exiting and entry devices. The backup technologies combined with cell phone technology utilizing the NFC or the like communication will severely reduce the need for costly smart exit and entry devices and the smart pay-on foot technology currently in the parking industry. This invention will also allow the ability to read the RFID chips that are embedded by the car manufacturers for tracking purposes.

### DETAILED DESCRIPTION OF THE INVENTION

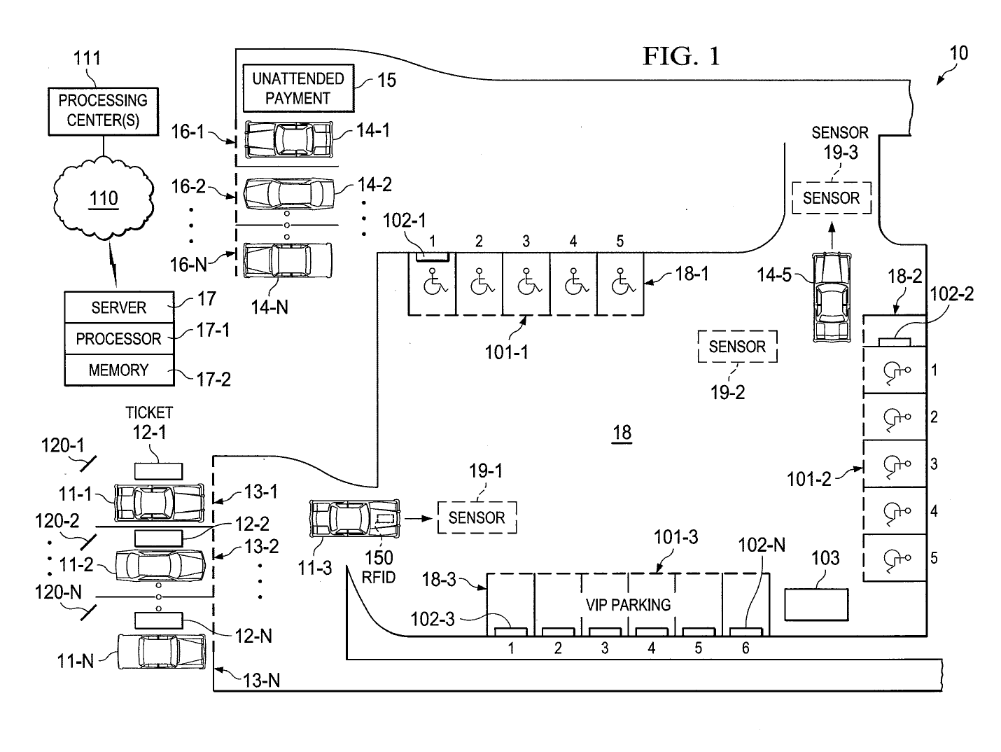

Turning now to FIG. 1, there is shown one embodiment 10 of a vehicle control system using the concepts of the invention in which server 17, having at least processor 17-1 and memory 17-2, controls the entry and exit of vehicle traffic onto and off of a piece of property, as well as other control functions pertaining to operation of the vehicle within the confines of the property. In this embodiment, there is shown entry gates 13-1 through 13-N with vehicles 11-1 to 11-N poised to enter, and exit gates 16-1 through 16-N with vehicles 14-1 to 14-N preparing to exit. Note that these gates could have traditional “arms” that raise to allow vehicles to pass or could be designed to simply allow cars to pass without a physical barrier. Note also that not all the entry/exit locations need be the same. For example, while the entry area may have physical barrier to entry (thereby encouraging vehicles to stop) the exit area may allow, at least in certain lanes, vehicles to pass through without stopping. Such a no-stopping situation is particularly helpful when the lane performs automatic processing on the vehicle and charges are made to the customer's account without any required activity on the part of the customer thereby leveraging off of the current and future cell phone technology that allows for seamless transactions.

In operation, entering vehicle 11-1 in lane 13-1 approaches the entry portal. Assuming that the driver or someone else in the car (customer) has a cell phone (or other electronic device) that is broadcasting a cell phone RFID number signal, then the cell phone RFID number signal is captured by a receiver contained, for example, in ticket dispenser 12-1. Currently, near field communication technology exists that requires a user to place the active cell phone a specific distance from a reader (receiver) which will eliminate any interference from any competing cell phone in a vehicle. The captured cell phone RFID number and data from the RFID paper ticket is delivered wirelessly or by wireline to server 17 for storage therein. For purposes of this application, we can assume that cell phones possess a form of RFID. Note that any communication protocol can be used in this invention but for cell phone communication the best mode contemplated at this time is near field communication (NFC). Also note that it is possible to imbed an RFID chip, such as chip 150 shown within vehicle 11-3, in a vehicle such that a cell phone is not necessary.

Ticket dispenser 12-1 then dispenses a paper (material other than paper could be dispensed but paper is the least costly option) RFID tag to the driver and server 17 then operates to associate the dispensed paper RFID tag data with the received cell phone RFID number and data and, if desired, with a digital imprint of the vehicle's license plate via input device 120-1, which can be, for example, current LPR technology to digitize the license plate number. The time, date, location of entry, and license plate together with any other control functions pertaining to operation of the vehicle within the property can then be recorded in server 17 all in association with the vehicle's user's cell phone RFID number. In this manner the dispensed paper RFID tag and the license plate that is captured by LPR technology act as a redundant backup to the vehicle (meaning this data is also sent and recorded in server 17) user's cell phone RFID number should the cell phone be turned off, lost, or the battery go low. If desired, the actual cell phone number can also be captured and stored in server 17 so that the system could send text messages to the customer from time to time. These messages could be, for example, telling the customer the current charges, where the vehicle is located, or even communicating information about the performance of maintenance (washing, oil change, etc.) on the vehicle while the customer is out of the car. Once all the information is captured then the vehicle can gain access to the property, for example by a gate, such as gate 13-1, lifting.

Assume now that a vehicle, such as vehicle 11-3, has come through the entry portal and thus the system now has stored in a database (server 17) the vehicle's cell phone RFID number in association with the backup paper RFID tag issued by the dispenser to that vehicle and also associated with (if desired) the vehicle's license plate number, all also associated with payment information of the customer. Note that when reference is made to a vehicle's user's cell phone, (cell phone RFID number or billing information, etc.) what is meant is that this information (while it identifies a particular vehicle vis-à-vis a cell phone user) is really information pertaining to a specific customer who is responsible for the vehicle while on this property. Thus, at different points in time the same vehicle could have different cell phone RFID numbers depending upon the driver (or a passenger) in the vehicle at the time when the vehicle enters the portal.

In the example, vehicle 11-3 proceeds into garage 18 and, if desired, sensor 19-1 picks up its presence in the garage. Sensor 19-1 tracks the fact that a vehicle has entered a specific area of the parking facility and this data can be sent back to the database (server 17) for storage and/or processing. The area location will be matched to the parker vis-à-vis the cell phone RFID number and the paper RFID tag number and other data in the “parker's data.” The sensor could be any type of sensor, such as a motion sensor, a weight sensor, an RFID sensor, a proximity sensor, or if the identity of the vehicle is desired then the sensor could pick up RFID or cell phone RFID number signals from the vehicle. This then serves, if desired, to know how many vehicles are in the facility and depending upon the strategic location of sensors around the facility can also serve to keep count of available spaces for each of a plurality of different categories. In some situations, knowing the identity of the vehicle can make specific sections available to this particular vehicle, for example, by raising a barrier arm to allow vehicle 11-3 to enter VIP parking area 18-3. If, for example, vehicle 11-3 pre-booked through a reservation through the web (or is otherwise assigned to) a particular parking space, such as to space 1 of area 18-3, then sensor 102-3 would determine the presence of vehicle 11-3 in space 1 and so notify the central system. Note the customer's cell phone number and/or their unique cell phone RFID number tied to their paper RFID tag number could be used as a key for this client to enter and park in the VIP area. A special rate would also be tied to this parker in this customer parker's data packet. If desired, if sensor 102-3 were to identify a vehicle not assigned or permitted in space 1 of area 18-3 then, if desired, some immediate action could occur. For example, a notice could light up (or a voice could announce) the fact that vehicle is improperly parked, or a siren could sound. In some situations, an agent can be dispatched to the offending location.

In some situations, the VIP space is not pre-assigned, but when a customer parks in such a space a premium can be charged. Thus, when sensor 102-3 detects the presence of vehicle 11-3 in space 1 of area 18-3 the data record associated with vehicle 11-3 is updated to show the actual space occupied and the time of such occupation. This is accomplished by reading the vehicle's user's cell phone RFID number or the issued paper RFID tag number and then a special rate will be charged to this customer. Note that in some situations sensor 1-2-3 will be designed to monitor space by space and in some situations an entire block of spaces will be monitored by a single sensor, such as for example, sensor 101-3. These sensors could be mounted in any position relative to the vehicle. For example, in some installations the sensor can be in front, in others it can be above and still other it can be on the floor under the vehicle.

Assume that vehicle 11-3 is not known to the system to have handicap permission and that vehicle parks in location 1 of area 18-2. In one embodiment, the vehicle can be warned that it is in the wrong location. In another embodiment, the driver can be instructed (verbally and/or visually) to scan or take a picture of, or otherwise enter, data pertaining to his/her placard (or license plate). The central server then can enter this information into the system in association with the cell phone RFID number and issued paper RFID tag number of this vehicle for subsequent use.

Upon leaving, sensors 19-2 and 19-3, if desired, will sense this fact and can thus declinate the vehicle occupancy counter. The exiting vehicle, such as vehicle 14-5, then can leave the location by passing through exit portal via one of the lanes 16-1 to 16-N. These lanes (16-1 thru 16-N) are automated payment lanes where parkers pay utilizing cell phone(s) using NFC technology or using the backup RFID tag number to pay with a credit card. Booth 15 can have automated pay-in-lane technology that will receive cash for those users who lost their paper RFID tag and their cell phone is not in use. For handicap or purple heart parkers, special authorized codes can be linked to cell phone RFID numbers or the patron can enter special codes for handicap designation or purple heart designation to be matched to said codes on file to allow such parkers access to these special areas. These special codes could be placed on file through the web. These parkers would have these codes pre-assigned and acquire the same special code for matching purposes added to their parker's data packet assigned to them. These handicap parkers or purple heart parkers would gain entry to the parking facility as would all other parkers. When the exiting vehicle approaches the exit portal, either the cell phone RFID number or paper RFID tag number of the existing vehicle is read and the database then calculates the proper amount based upon services rendered to the vehicle while in the area. These services could be, for example, time of parking, exact location of parking, washing, lubricating, valet, etc. Once the fee calculation is performed by the computer system, the charges can be levied against a pre-identified account of the user as determined by the cell phone associated with the cell phone RFID number information gathered when the vehicle entered the portal.

In some situations, the system can operate to pre-authorize vehicles for the anticipated charges such that when the vehicle approaches the exit portal the system already knows there is proper credit. In some embodiments, if the cell phone RFID number associated with a particular vehicle has an anticipated payment problem a notice can be placed on the windshield of the vehicle while the occupant is gone from the vehicle notifying the customer of the problem. This can be accomplished, for example, when the system monitors which parking location or which area the vehicle is parked in. In extreme situations a “boot” can be placed on the vehicle preventing the vehicle from leaving the parking space. This could occur, for example, when a vehicle has repeatedly used a facility (or any associated facility) and failed to pay (or the billing information is found to be in error). An alternative to the “boot” could be that the vehicle is met by the authorities before exiting the garage or the location. This “meeting” can be facilitated by monitoring when a particular vehicle is moving from a parking space.

In situations where the driver does not have a cell phone upon entry to the location the dispensed paper RFID tag serves as the primary locator. The use of the RFID card alone without the cell phone RFID number could, in some situations, result in the parker having fewer parking options and the parker may have to be closer to a sensor than he/she would have to do when using an cell phone RFID number device.

In situations where a parker has lost his/her cell (or battery is low) and the RFID is missing, the database can be entered, for example by using the license plate or the phone number, and the user informed of the location.

In those situations where payment is made before returning to the vehicle, the customer would use his/her cell phone RFID number or paper RFID tag at a pay-on-foot station (POF), for example at POF 103, to pay the fees based upon time and location of the parked vehicle and any other adjustments that need to be made. This POF would have attendantless pay-on-foot technology that recognizes RFID technology and NFC ready readers. When the customer then passes out of the facility the system will sense the cell phone RFID number and/or RFID tag and know that the proper amount has been paid. Otherwise, the exit gates will not open and the parker will not be permitted to leave the facility.

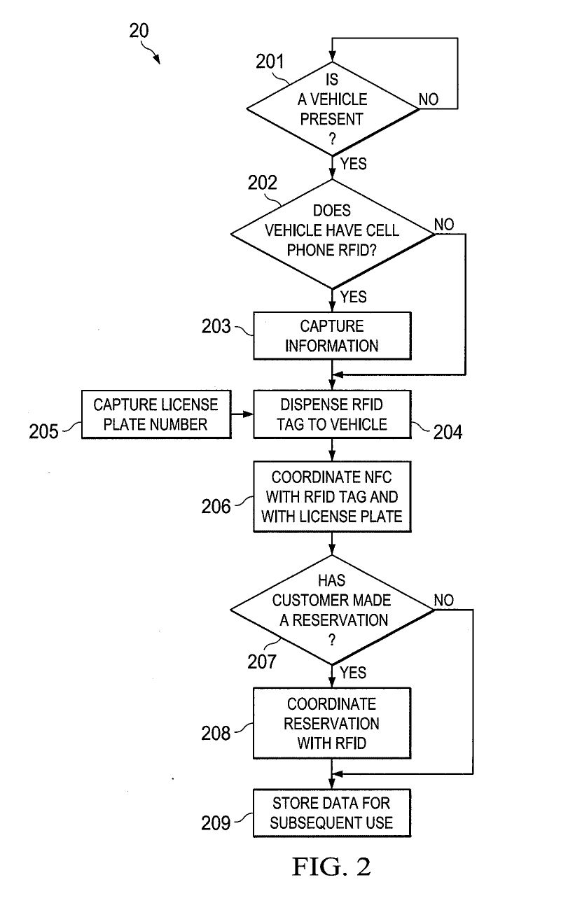

FIG. 2 shows one embodiment 20 of the operation of a control system for coordinating an entering vehicle's user's cell phone RFID number with a dispensed RFID tag. Process 201 determines when a vehicle has approached an entry portal. If the vehicle has an electronic cell phone RFID number process 202 causes process 203 to capture it. At the same time, process 204 causes a paper RFID tag to be dispensed to the driver while process 205, if desired, captures the vehicle license number and digitizes it for storage in the database. If a cell phone RFID number has been detected then the cell phone RFID number code is associated with the issued paper RFID tag number and with the license number and in some situations with the phone number of the device associated with the cell phone RFID number. This then creates a coordinated record under control of process 206.

If this vehicle is entitled to special parking or other special treatment due to a reservation or other prerequisites, such fact can be determined by process 207 at this time and if so, process 208 associates the reservation with the record of the vehicle and process 209 stores the record in memory 17-2 of server 17. If immediate action is to occur, then the proper action is taken, all under control of server 17.

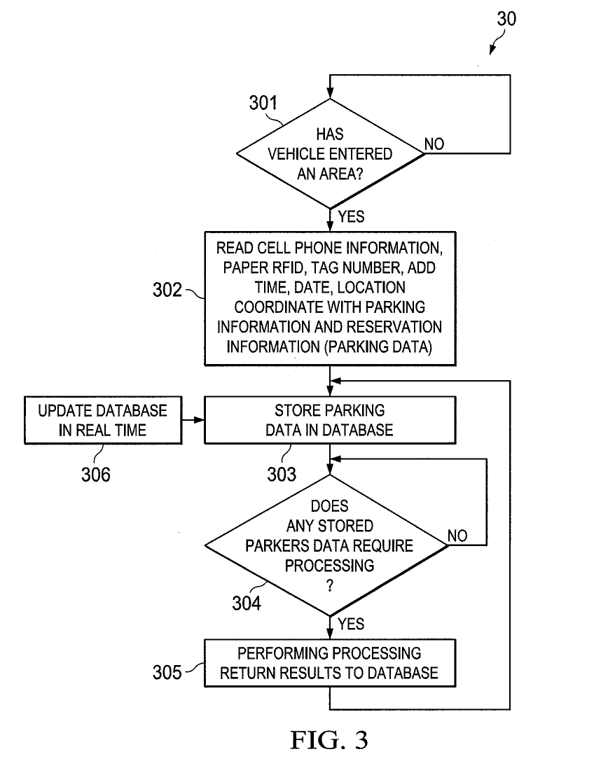

FIG. 3 shows one embodiment 30 of the operation of a control system for coordinating parking locations within a facility on a per vehicle basis. Process 301 determines if a vehicle has entered a specific area. When it has, process 302 reads the cell phone RFID number or dispensed paper RFID tag signals and adds the time, location, date, unique reservation number, etc. (parker's data) and process 303, in conjunction with process 306 then stores this information together with the record information for the particular vehicle.

Process 304 determines if any stored paper RFID tag number/cell phone RFID number or any parker data requires immediate processing. Such processing, as above discussed, can be to determine credit history, verify proper billing information, verify handicap or other parking privilege status, ascertain criminal activity and process reservation status. Process 305 then performs any such necessary processing and sends out any necessary notifications. These notifications can be text or e-mail messages to the associated cell phone, verbal and/or visual commands to the parking location, authority alerts, etc.

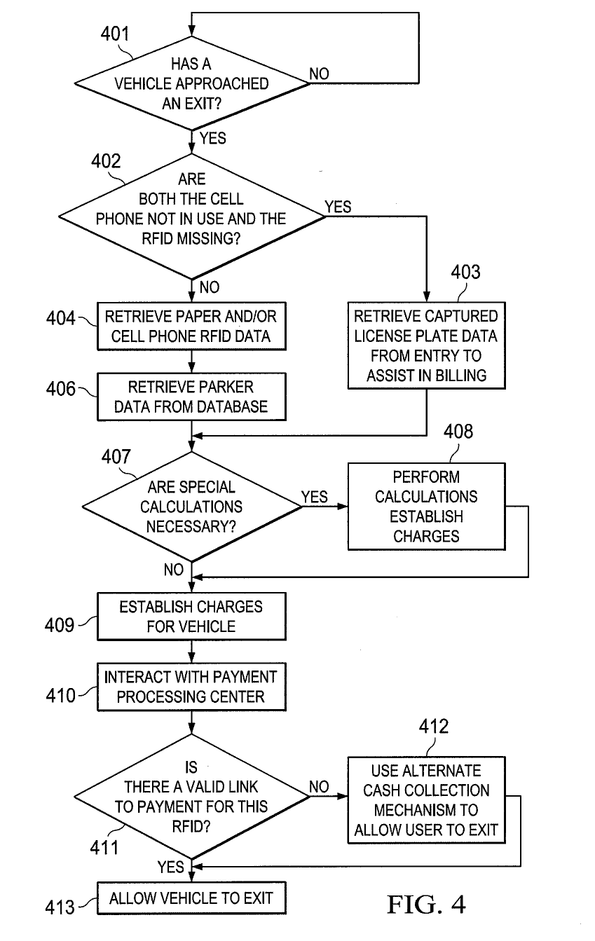

FIG. 4 shows one embodiment 40 of the operation of a control system for processing a vehicle leaving the premises and for automatically controlling billing for services, such as the use of a parking facility or use of the reserved parking facility (area). Process 401 determines when a vehicle has approached an exit portal. If process 402 determines that an RFID number is missing (for example, when the vehicle leaves the parking facility without use of a paper RFID tag and/or cell phone RFID number signal is noted), or if another special handling situation is detected, then the vehicle is directed to an attendant gate control point. A bad credit report could trigger such handling. Under special handling, the agent in conjunction with process 403 can retrieve the parker's license plate data from the database at server 17 captured when the vehicle entered the parking facility or when vehicle license plate was captured at the time of premise inventory (utilizing mobile LPR technology). Note at this special handling center, the license plate can be captured at this exit automatically or typed in by an agent and then matched to the license plate in the database so that the elapsed time and associated parking fee can be calculated. The license plate routine just described is useful for lost paper dispensed tickets when the cell phone is not in use. In other situations, the license plate number can be used to enter the system to find the record on the vehicle as created initially by the RFID/cell phone RFID number system discussed above.

If process 402 finds that the paper RFID tag or the cell phone RFID number signals are available then process 404 reads those signals and under control of process 406 retrieves the associated record and parker data along with the exit time from database storage. Process 407 determines if special calculations are necessary and, if so, process 408 performs such calculations determining the elapsed time and the associated parking fee. Process 409 then finalizes a charge for services rendered to the vehicle such as parking, gas fill-up, car wash, etc. Process 410 then interacts with the proper payment processing center, clearing house or bank which for cell phone users could be the telephone billing system.

Process 411 determines if the retrieved information is a valid link for payment and, if not, process 412 determines and alternate payment method, such as cash. Once payment has been established, process 413 authorizes the vehicle to leave the property, for example, by lifting a physical barrier or illuminating a sign.

Note that while RFID paper tags have been discussed herein as the best mode contemplated for providing the backup RFID, any remotely readable signal having a unique signature could be used. In some situations it might be possible to attach the tag to the vehicle or even to “program” an existing tag with temporary remotely readable unique signal capability. For example, it may be possible to place a transmitter near a vehicle as it passes into a facility and to transmit an electronically unique signal that is captured by the vehicle for the duration of the time the vehicle is within the facility. Such tags could be dispensed as active RFID tags to utilize as passes for hang tags for special areas in the parking facility (like handicap, VIP or reservation parkers). In some situations, this “programmed” signal might be stored in a transmitter within the vehicle for rebroadcast by the vehicle transmitter from time to time (or even continuously). Also note that while the phone device contemplated uses near filed transmission it also could be designed to use broadcast capability triggered externally or by the driver or even continuously.

As shown, process 50 controls access to the database, such as database 17-2 which is controlled by server 17. Process 501 accepts a validation routine from a user attempting to gain access to the system. Process 502 determines if the user is a valid user. If not, process 505 blocks entrance and if desired, sends an alarm signal. If the user is valid, then an RFID in the possession of the user activates the proper security profile associated with the RFID data and with the login information. Process 504 then allows access to different areas, such as credit card data, payment data, etc., depending upon the security profile activated for this user at this time.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for monitoring vehicle activity within a confined area, said method comprising:
issuing a temporary tag to each vehicle entering said confined area, said tag containing a remotely readable signal having a signature unique to said issued tag;
associating in a database an identity of said issued tag with an identity of a remotely readable signal having a signature unique to an electronic device within said vehicle; and
while within said area using said tag signal interchangeably with said device signal to provide control functions pertaining to operation of said vehicle within said area.

2. The method of claim 1 wherein said issued tag is a paper tag having embedded RFID technology.

3. The method of claim 1 wherein said device signal is a cell phone RFID number signal utilizing near field communication.

4. The method of claim 1 wherein said device signal is an embedded RFID chip in a vehicle's electronics.

5. The method of claim 1 further comprising:
further associating in said database a license plate number of said vehicle.

6. The method of claim 1 wherein one of said control functions comprises:
permitting said vehicle to park in a particular parking location.

7. The method of claim 6 wherein said particular parking location is reserved for said vehicle based upon an identity of said device signal.

8. The method of claim 6 wherein said permitting comprises allowing said vehicle to enter specific parking areas.

9. The method of claim 6 wherein said permitting comprises allowing said vehicle to enter an area having a plurality of parking spaces.

10. The method of claim 1 further comprising:
upon exiting said area, calculating a fee based upon services rendered to said vehicle while in said area, said fee calculation based upon reading signals from either said tag or said device remotely readable signal.

11. A system for monitoring vehicle activity within a confined area, said system comprising:
a dispenser for issuing a temporary tag to each vehicle entering said confined area, said tag containing a remotely readable signal having a signature unique to said issued tag;
a first receiver for receiving a remotely readable signal from an electronic device within said vehicle when said vehicle enters said confined area; said received device signature unique to said device;
a processor for associating a received device signal from a particular vehicle with a tag dispensed to said particular vehicle;
at least one second receiver within said confined area for receiving either said device signals or said tag signals from said particular vehicle from time to time; and
wherein said processor associates in a same database record received signals from said particular vehicle via said second receiver whether said received signals originated from said tag or from said device.

12. The method of claim 11 wherein said issued tag is a paper tag having embedded RFID technology.

13. The method of claim 11 wherein said device signal is a cell phone RFID number signal utilizing near field communication.

14. The method of claim 11 wherein said device signal is an embedded RFID chip in a vehicle's electronics.

15. The system of claim 11 further comprising a plurality of said second receivers positioned at different locations within said area, each said second receiver positioned to receiving either said device signals or said tag signals from vehicles from time to time depending upon physical location of said vehicles.

16. The system of claim 15 further comprising:
means for authorizing certain activities for a particular vehicle depending upon data contained in a database record maintained for said particular vehicle while said particular vehicle is within said area, wherein at least some of said data in said record attainable via said signals received by one or more of said second receivers.

17. The system of claim 16 wherein one of certain activities comprises parking in a particular parking location.

18. The system of claim 17 wherein said particular parking location is reserved for said vehicle based upon an identity of said device signal.

19. The system of claim 11 further comprising:
a receiver for reading a license plate number of said particular vehicle; and
wherein said processor is operable for associating in said database record of said particular vehicle said particular vehicle license plate number utilizing LPR digitizing technology.

20. The system of claim 16 wherein said tag is a paper tag and said device is a cell phone, said system further comprising:
a third receiver for receiving either said cell phone signals or said paper RFID tag signals from said particular vehicle when said particular vehicle is leaving said area; and
wherein said processor retrieves a database parker record associated with said particular vehicle based upon received signals from said third receiver whether said received signals originated from said paper RFID tag or from said cell phone and based upon said retrieved parker record calculates a fee based upon services rendered to said vehicle while in said area as contained in said retrieved record based upon signals received from said second receivers.

21. A processor for controlling a parking lot system, said processor comprising:
code for associating in a record stored in a computer an identity of a signal generating a paper RFID tag temporarily issued to a vehicle upon entry of said vehicle to a premises;
code for storing in said vehicle record an identity of a cell phone RFID signal generating device associated with said vehicle, said device associated with said vehicle prior to or upon entering said premises; and
code for associating with said vehicle record control function occurrences obtained from time to time from received identities of either said paper RFID tag signals or said cell phone device signals.

22. The processor of claim 21 further comprising:
code for associating in said vehicle record a license plate number of said vehicle.

23. The processor of claim 22 wherein one of said control functions comprises permitting said vehicle to park in a particular parking location.

24. The processor of claim 23 wherein said particular parking location is reserved for said vehicle based upon an identity of said cell phone device signal.

25. The processor of claim 23 wherein said particular parking location is reserved for said vehicle based upon an identity of an embedded chip in a vehicle's electronics.

26. The processor of claim 23 wherein said permitting comprises allowing said vehicle to enter a specific parking space.

27. The processor of claim 22 further comprising:
code for calculating a fee based upon services rendered to said vehicle while in said area, said fee calculation based upon reading signals from either said paper RFID tag or said electronic cell phone or from an embedded RFID chip in a vehicle's electronics.

28. A system for controlling a parking lot system, said system comprising:
means for associating in a record stored in a computer an identity of a signal generating paper RFID tag temporarily issued to a vehicle upon entry of said vehicle to a premises;
means for storing in said vehicle record an identity of a cell phone device signal generating device associated with said vehicle, said device associated with said vehicle prior to or upon entering said premises; and
means for associating with said vehicle record control function occurrences obtained from time to time from received identities of either said paper RFID tag signals or said cell phone or from an embedded RFID chip in vehicle's electronics.

29. The system of claim 28 further comprising:
means for associating in said vehicle record a license plate number of said vehicle.

30. The system of claim 29 wherein one of said control functions comprises permitting said vehicle to park in a particular parking location.

31. The system of claim 30 wherein said particular parking location is reserved for said vehicle based upon an identity of said cell phone device signal and associated unique RFID number and said paper RFID or based on an embedded RFID chip in said vehicle.

32. The system of claim 31 wherein said permitting comprises allowing said vehicle to enter a specific parking space.

33. The system of claim 22 further comprising:
means for calculating a fee based upon services rendered to said vehicle while in said area, said fee calculation based upon reading signals from either said paper RFID tag or said cell phone or from an embedded RFID chip in said vehicle's electronics.
